(19) United States
(12) Patent Application Publication
(10) Pub. No.: US 2007/0011166 A1
(43) Pub. Date: Jan. 11, 2007

(54) Method and apparatus for providing multi-view of files depending on authorization

(76) Inventor: Takaki Nakamura, Kokubunji (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/212,665

(22) Filed: Aug. 29, 2005

(30) Foreign Application Priority Data
Jul. 5, 2005 (JP) 2005-196247

(51) Int. Cl. G06F 7/00

(52) U.S. Cl. 707/9

(57) ABSTRACT

This invention provides a file system capable of finely changing the view of a file based on an access authorization. A file providing method for providing file data corresponding to an access authorization for an access source, satisfies: setting an access authorization for each of data in a predetermined region of a file; concatenating the data satisfying the access authorization for the access source according to a predetermined combination; and providing the access source with the concatenated data.

### CLAIM OF PRIORITY

The present application claims priority from Japanese application P2005-196247 filed on Jul. 5, 2005, the content of which is hereby incorporated by reference into this application.

### BACKGROUND

This invention relates to a file providing method, a storage system, and a file providing program for providing a file system capable of finely changing the view of a file based on an access authorization.

In a conventional access management method using a file system or a file server, access authorizations for users are set in respective files, and the possibility or impossibility of access to the entire contents of the files is managed based on the access authorizations.

There are various methods for accessing a file, for example, conventional access management by “permission” of UNIX. In the permission, permission or rejection is set for each of three access methods, namely, reading (R), writing (W), and execution (X). Furthermore, each of the access methods is associated with a user account, a group account, or other accounts. Thus users' access is managed.

Further, an access management method “ACL” (access control list) is a more departmentalized version of an access method. There are various types of ACL. The major ones are POSIX ACL, NTFS ACL, and NFS ACL. For instance, NFS ACL has six writing methods, that is, the overwriting of contents (WRITE_DATA), the additional writing of contents (APPEND_DATA), the writing of named attributes (WRITE_NAMED_ATTRS), the writing of base attributes (WRITE_ATTRIBUTES), the writing of ACL information (WRITE_ACL), and the changing of owner authorization (WRITE_OWNER), and is capable of managing access authorizations in a departmentalized manner (see http://www.ietf.org/rfc/rfc3530.txt?number=3530).

In addition to the aforementioned methods, there is another one called WORM (Write Once Read Many). WORM represents an authorization having such a property that the contents can never be reedited after having been written once. WORM has not been standardized currently and is considered to be proprietary by various firms.

There is also a method in which access authorizations are departmentalized in granularity not in the entire contents but in regional areas thereof. For example, there is disclosed a textual region access control method in which a text is divided into regions based on security level and those regions are protected by their specific passwords (see JP 01-243172 A).

There is also disclosed a method of finely managing access authorizations or changing the appearance of a file based on access authorization by means of a structured language such as XML. More specifically, when an arbitrary display region on a display screen displaying a retrieval result text including plural components, which is obtained as a result of conducting retrieval from a structured text database using a retrieval request sentence for retrieving a desired one of the components based on a logic structure of the database, is designated, a first component in the retrieval result text corresponding to data displayed on the designated display region is specified. Based on a description of a second description part in a retrieval request sentence associated with the first component, a second component corresponding to the first component in the structured text database is retrieved. A range of users who are restrained from accessing at least the second component is determined and an access authorization is set for the second component (see JP 2003-281149 A).

In the sense of file virtualization, a file is finely divided into plural files, and a metafile for making them look like a single file is described (see JP 10-214257 A). More specifically, a logical file is divided into plural files and stored into secondary storage systems on plural I/O nodes while the inputting/outputting of the files is carried out. A metafile representing the logical file is prepared to associate the logical file with entities of the files stored on the respective I/O nodes. The metafile is provided on a secondary storage system that can be referred to from all calculation nodes. In generating the logical file, the number of files into which the logical file is divided and the length of data into which the logical file is divided can be designated.

Another method of file virtualization is “cdf” (context dependent files) of HP-UX (see http://www.informatik.unifrankfurt.de/doc/man/hpux/cdf.4.html). According to this method, file virtualization is realized by selecting as an entity a file under a directory generated as cdf when a file name thereof matches a character string registered as context information.

A database also has a function called view, which makes it possible to change the appearance of a table based on access authorization.

### SUMMARY

The enactment of a law for protecting personal information or a social background such as the damage of corporate brand images resulting from information leaks enhances the importance of tackling information security issues. On the other hand there are also attempts to energize business enterprises by positively transmitting and sharing information. Those activities are in a trade-off relationship, and it is required to block access to confidential information from outsiders while effectively sharing information.

In conventional file systems, the possibility/impossibility of access to the entire file is set using a management method according to the aforementioned permission or ACL. That is, the granularity of access restriction is approximately equal to that of a file as a unit. Accordingly, when it is desired to partially lay open (permit access to) some of the contents of the file, another file different from the original one needs to be created. In other words, a file having less informative contents is created based on the contents of an original file and laid open. In this case, the ease of maintenance of the contents deteriorates substantially. In other words, when the file having original contents is corrected, the file having less informative contents needs to be corrected as well. Further, since the number of files increases according to the level of publication, the cost for managing the files increases as well.

In the field of image contents, there has been a demand to provide different viewers with different images. This demand can be met by dividing a file into file sections, selecting appropriate file sections for the viewers individually, and connecting the selected file sections. In this case, however, it is necessary to determine how to select those file sections by means of a superordinate application program or script. In a method of realizing access restriction within file data by means of a structured language such as XML, the superordinate application program is required to understand the structured language such as XML. Therefore, the method does not have a smooth transition from conventional environments.

As described above, the method of partially or entirely changing the view of contents based on access authorization leads to an increase in the cost for managing files. Further, the ease of maintenance of the contents deteriorates as well. There is also a problem of the lack of smoothness in making a transition from conventional file system environments.

This problem will be described more specifically.

Each of FIGS. 20 and 21 is an explanatory diagram showing an example of a method of providing a file according to a conventional file system.

FIG. 20 shows examples of three kinds of text files. The contents of the respective files are similar to one another, but partially different from one another. Each of the contents relates to a budget in the current term. The file A includes a concrete amount of the budget. The file B includes only an amount of increase or decrease compared with a budget in the previous term, instead of the concrete amount of the budget. The file C does not include the contents of the budget, which are masked with “x”. In the case of this example, the part “CURRENT-TERM_BUDGET_FOR_Y_DEPARTMENT_IS_” and the part “_YEN.” are common to the respective files. The contents of the file B are obtained by making those of the file A less informative. By the same token the contents of the file C are obtained by making those of the files A and B much less informative.

FIG. 21 shows the structure of a file system volume in the case where the three files shown in FIG. 20 are stored in a conventional file system.

Metadata 301a indicate information on the file A. The metadata include a region for storing file attributes and a region (extent) indicating in which file system block data are stored. This extent includes a leading offset, a number of blocks, and a block number.

The file A has a small data capacity and therefore can be stored into a single file system block. The number of blocks is thus set to 1. The block number indicates 0x122, which means that user data as an entity of the file A are stored from the leading offset 0 to the block number 0x122. Stored in user data 302a with the block number 0x122 is a character string “CURRENT-TERM_BUDGET_FOR_Y_DEPARTMENT_IS_{—}100M_YEN.”.

Similarly in the file B, the contents included in metadata 301b indicate user data 302b. Similarly in the file C, the contents included in metadata 301c indicate user data 302c.

The file attributes of the metadata 301a, 301b, and 301c include access authorizations for the respective files. For instance, only users or groups corresponding to executive officers are authorized to access the file A. Further, only users or groups corresponding to managerial officials are authorized to access the file B. Still further, only users or groups corresponding to employees are authorized to access the file C.

In the conventional file system, as described above, in order to make the contents of the files different depending on the respective access authorizations, they must be made different from one another even when they are similar to one another. In this example, three kinds of data are created and stored as different files, to which appropriate pieces of information on access authorization are attached respectively. It is thus necessary to store different files for different access authorizations respectively.

This invention is made in consideration of the problem discussed above and has an object of providing a file providing method, a storage system, and a file providing program for providing a file system capable of finely changing the view of a file based on an access authorization.

According to this invention, there is provided a file providing method for providing file data corresponding to an access authorization for an access source, including: setting an access authorization for each of data in a predetermined region of a file; concatenating the data satisfying the access authorization for the access source according to a predetermined combination; and providing the access source with the concatenated data.

According to this invention, it is possible to realize sophisticated access management and flexible information sharing in a compatible manner. It is also possible to reduce the cost for managing files and enhance the ease of maintenance of contents. Furthermore, this invention can provide file views suited for respective users while maintaining a smooth transition from conventional file system environments.

### BRIEF DESCRIPTION OF THE DRAWINGS

FIG. 1 is a schematic diagram of a file system realized by a computer system according to a first embodiment of this invention.

FIG. 2 is a block diagram of a configuration of the computer system realizing the file system.

FIG. 3 is an explanatory diagram of concrete contents of a file system volume.

FIG. 4 is an explanatory diagram of details of an area limitation access control.

FIG. 5 is an explanatory diagram of details of a stream access priority.

FIG. 6 is an explanatory diagram of details of a default stream rule.

FIG. 7 is a flowchart of a processing of an attach_stream system call.

FIG. 8 is a flowchart of a processing of a detach_stream system call.

FIG. 9 is a flowchart of a processing of a show_stream system call.

FIG. 10 is a flowchart of a processing of a setracl system call.

FIG. 11 is a flowchart of a processing of a getracl system call.

FIG. 12 is a flowchart of a processing of an open system call.

FIG. 13 is a flowchart of a processing of an insert system call.

FIG. 14 is a flowchart of a processing of a cut system call.

FIG. 15 is a flowchart of a processing of a write system call.

FIG. 16 is a flowchart of a processing of a switch system call.

FIG. 17 is a flowchart of a processing of a read system call.

FIG. 18 is a flowchart of a processing of a seek system call.

FIG. 19 is a schematic diagram of a file system realized by a computer system according to a second embodiment of this invention.

FIG. 20 is an explanatory diagram showing an example of a method of providing a file according to a conventional file system.

FIG. 21 is an explanatory diagram showing an example of a method of providing a file according to another conventional file system.

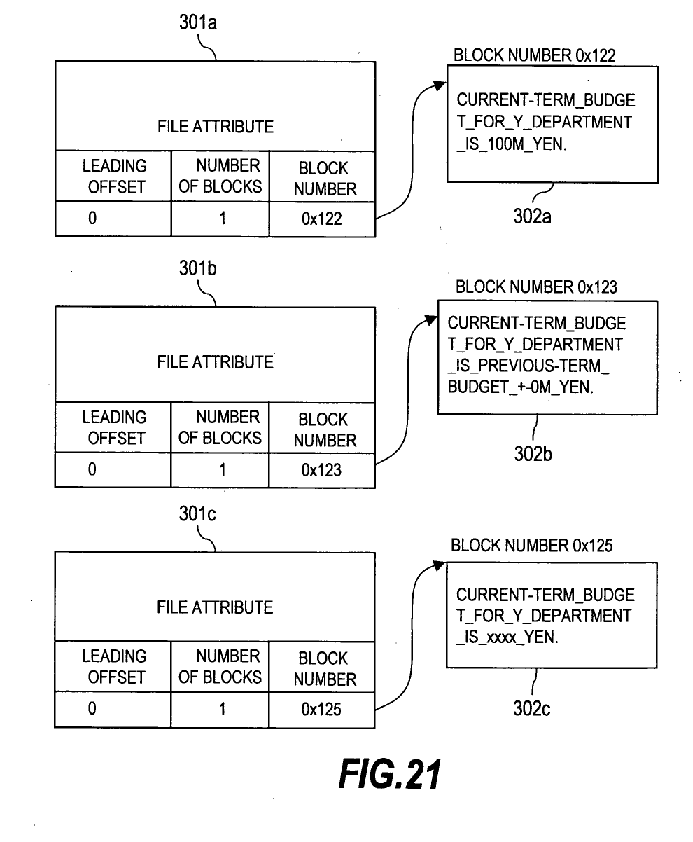

### DESCRIPTION OF THE PREFERRED EMBODIMENTS

Hereinafter, embodiments of this invention will be described with reference to the drawings.

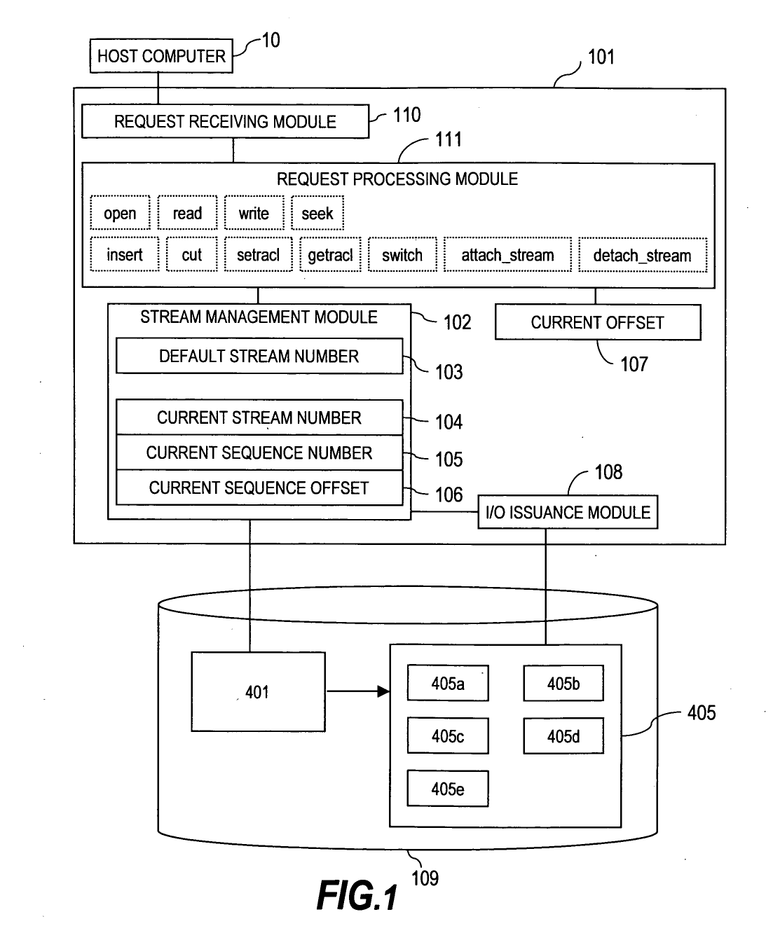

FIG. 1 is a schematic diagram of a file system realized by a computer system according to a first embodiment of this invention.

A file system 101 receives a request from a host computer 10 and provides access to a file stored in a file system volume 109.

The file system 101 includes a request receiving module 110, a request processing module 111, a stream management module 102, a current offset 107, and an I/O issuance module 108.

The file system volume 109 stores user data 405 and metadata 401.

Upon receiving a request from the host computer 10, the request receiving module 110 analyzes the contents of the request and issues a system call to the request processing module 111. The request processing module 111 processes the system call from the request receiving module 110. Specifically, system calls processed by the request processing module 111 are provided in a conventional file system. Those system calls include “open”, “read”, “write”, and “seek”, which have been improved according to this invention, and “insert”, “cut”, “setracl”, “getracl”, “switch”, “attach_stream”, and “detach_stream”, which are provided in the file system of this embodiment. The details of the processings of those system calls will be described later.

In addition, the file system of this embodiment supports system calls such as “close” and the like, which are supported by the conventional file system. However, since those system calls are irrelevant to the gist of this invention, their description will be omitted.

The stream management module 102 and the I/O issuance module 108 are interfaces with the file system volume 109.

The current offset 107 is an identifier indicating which position of a file is about to be accessed at the moment. This identifier is set by a file descriptor as a basic function of the file system. The current offset 107 is stored using the “open” system call of the file as a unit.

The file system of this embodiment has more pieces of information that are stored using the “open” system call of the file as a unit. More specifically, the stream management module 102 includes a default stream number 103 designating which stream number should be checked first in respect of an access authorization, a current stream number 104 indicating which stream number is about to be accessed, a current sequence number 105 and a current sequence offset 106 which respectively indicate which sequence number and which offset thereof are about to be accessed.

The file system volume 109 stores data operated by the file system 101. The data include the metadata 401 and the user data 405.

The metadata 401 include file management information. The user data 405 are file entities represented by the metadata. FIG. 1 shows, for the sake of simplicity, a state in which the file system volume 109 stores only one file. In fact, the file system 109 can store plural files.

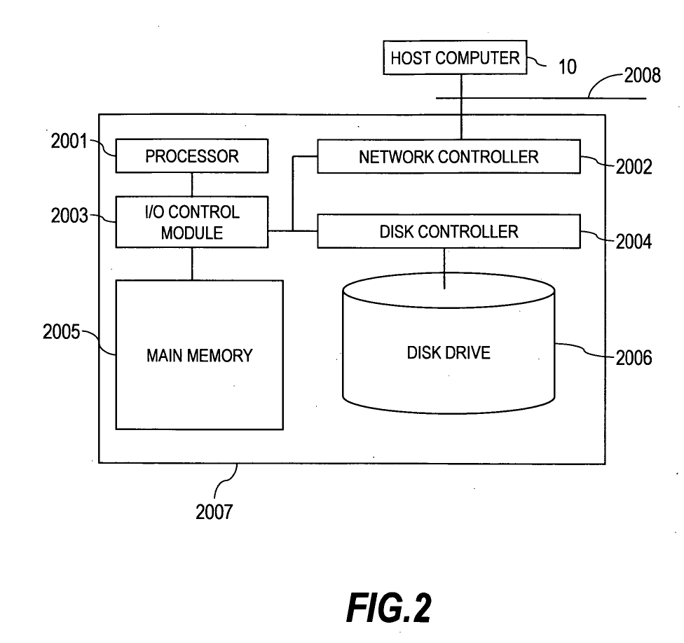

FIG. 2 is a block diagram of a configuration of a computer system realizing the file system 101.

A storage system 2007 is connected to the host computer 10 via an external network 2008.

The storage system 2007 includes a processor 2001, an I/O control module 2003, a main memory 2005, a network controller 2002, a disk controller 2004, and a disk drive 2006. One or a plurality of those components may be included.

The network controller 2002 sends/receives data to/from the host computer 10 via the external network 2008.

The main memory 2005 retains various programs. When the processor 2001 reads and executes those programs, processings defined by the programs are thereby performed. More specifically, when the processor 2001 executes the programs, respective processings of the file system I/O issuance module 108 are thereby realized.

Further, the main memory 2005 retains various kinds of information that are processed by the request receiving module 110, the request processing module 111, the stream management module 102, and the I/O issuance module 107. For instance, the main memory 2005 stores the current offset 108. Also, the main memory 2005 functions as a cash memory for data in the file system volume 109.

The I/O control module 2003 relays data sent and received by the respective modules of the storage system 2007. The disk controller 2004 reads and overwrites data stored in the disk drive 2006.

The disk drive 2006 retains the file system volume 109. The disk drive 2006 includes, for example, one or plural magnetic disk devices, on which the file system volume 109 is configured.

Next, the file system of this embodiment will be described.

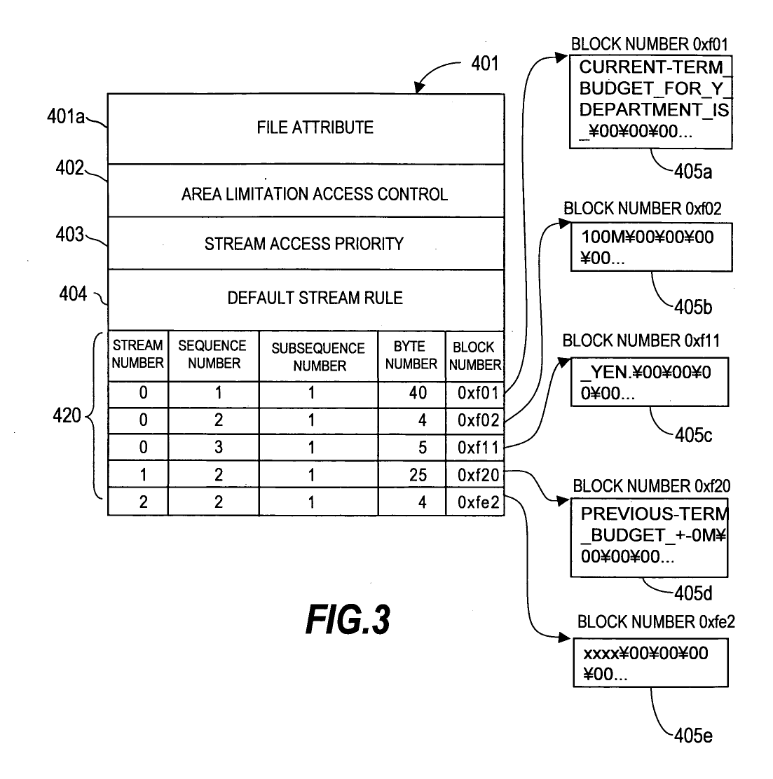

FIG. 3 is an explanatory diagram of the concrete contents of the file system volume 109.

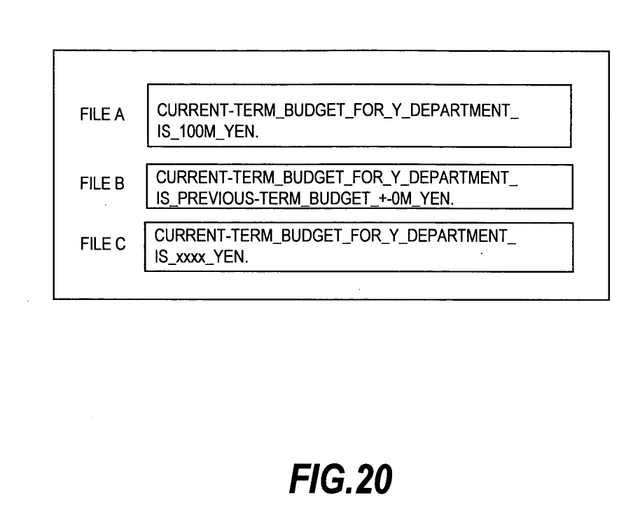

This figure shows a management structure in the case where the file system of this embodiment provides the aforementioned contents shown in FIG. 20.

In this embodiment, files to be provided to a client are managed using a unit called “stream”. A stream is obtained by dividing a file into some blocks and connecting them according to a predetermined order. Information on this stream is stored in the metadata 401.

The metadata 401 include a file attribute 401a, an area limitation access control 402, a stream access priority 403, a default stream rule 404, and an extent 420.

As is the case with the conventional file systems, the file attribute 401a retains access authorizations per file, file name, file length, and the like.

The area limitation access control 402 retains information for managing which user should be authorized to access which area of which stream.

The stream access priority 403 retains information used in confirming an access authorization. More specifically, when checking an access authorization, the file system 101 refers to the stream access priority 403 and determines which stream number should be checked first as to the authorization.

The default stream rule 404 retains information for setting a default stream that is given priority to be checked by the stream access priority 403 as to an authorization.

The extent 420 retains information on a file structure indicated by the metadata 401. More specifically, the extent 420 includes a stream number, a sequence number, a subsequence number, a byte number, and a block number of the file. The sequence number and the subsequence number are indexes for relatively indicating to which position of the file indicated by the metadata 401 each datum belongs.

A file is indicated by the metadata 401 as follows.

A stream having a stream number 0 is referred to as a main stream. A stream having a stream number 1 or more is referred to as a sub stream. The main stream represents a main structure of data indicated by the sequence number and the subsequence number. The sub stream is a substitute for the same sequence number as included in the main stream.

More specifically, a single datum is expressed by a combination of [stream number-sequence number-subsequence number]. A view corresponding to the main stream is obtained by concatenating data with the stream number 0 in the order of sequence number.

In the example of FIG. 3, a view corresponding to the main stream is obtained by concatenating data of [0-1-1], [0-2-1], and [0-3-1]. Those data correspond to block numbers 0xf01, 0xf02, and 0xf11, respectively. A view corresponding to the file A of FIG. 20 is obtained by concatenating those data.

Further, when the stream number is 1, the datum expressed by a sequence number 2, which is the same sequence number as that of the main stream, and by the subsequence number 1 substitutes for the main stream. Accordingly, a view corresponding to a sub stream 1 is obtained by concatenating the data of [0-1-1], [1-2-1], and [0-3-1]. This is a view corresponding to the file B of FIG. 20.

Similarly, a view corresponding to a sub stream 2 is obtained by concatenating the data of [0-1-1], [2-2-1], and [0-3-1]. This is a view corresponding to the file C of FIG. 20.

In this manner, the three contents shown in FIG. 20 are integrated into a single file. The file is composed of the metadata 401 and fragmentized user data 405a, 405b, 405c, 405d, and 405e.

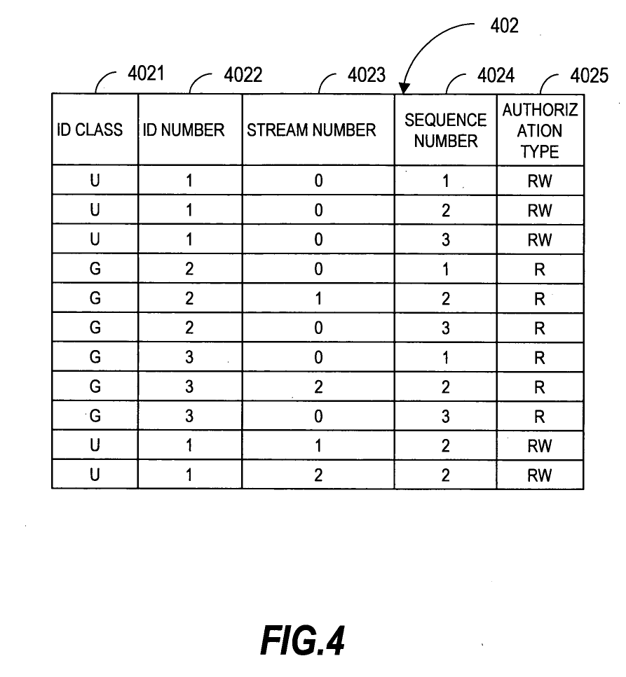

FIG. 4 is an explanatory diagram of the details of the area limitation access control 402.

The area limitation access control 402 is a list composed of one or plural entries including respective fields, namely, an ID class 4021, an ID number 4022, a stream number 4023, a sequence number 4024, and an authorization type 4025.

The ID class 4021 is an identifier indicating whether the value of an ID number field belongs to a user ID or a group ID.

The ID number 4022 is a unique number allocated to each user or each group. The value of the ID number 4022 indicates for which user or group access control is performed. The ID number 4022 may store an identifier such as a character string corresponding to a user name or a group name, instead of a number.

The stream number 4023 and the sequence number 4024 indicate for which area, namely, for which stream number and which sequence number access control of the relevant entry is performed. To indicate the area, it is also appropriate to store a file offset instead of the sequence number.

The authorization type 4025 is an identifier indicating an authorization type such as a reading authorization (R), a writing authorization (W), or the like. Although FIG. 4 shows only two authorization types for the sake of simplicity, it may store a variety of other authorization types, for instance, a WORM authorization.

By referring to the area limitation access control 402, the file system 101 can obtain the access authorization for a corresponding stream.

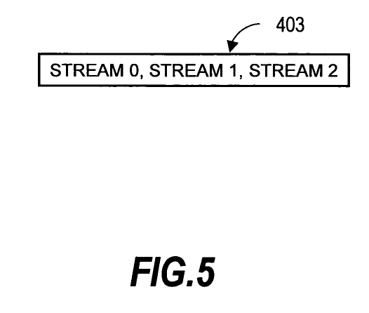

FIG. 5 is an explanatory diagram of details of the stream access priority 403.

The stream access priority 403 represents a rank for checking an access authorization in referring to a stream indicated by the extent 420.

In the example of FIG. 5, the file system 101 checks access authorizations for the stream 0, the stream 1, and the stream 2 in this order.

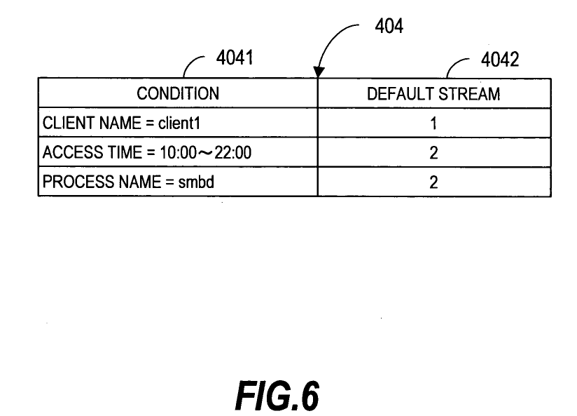

FIG. 6 is an explanatory diagram of details of the default stream rule 404.

The default stream rule 404 includes a condition 4041 and a default stream 4042.

The file system 101 refers to the default stream rule 404, and sets a stream indicated by the default stream 4042 as an access target stream when the condition 4041 is fulfilled.

In the example of FIG. 6, the first entry sets the default stream to “1” when there is an access from a client name “client1”. Further, the second entry sets the default stream to “2” when the access hour is from 10:00 to 22:00. Further, the third entry sets the default stream to “2” when there is an access from a process name “smbd”.

Next, the system calls provided by the file system 101 of this embodiment will be described.

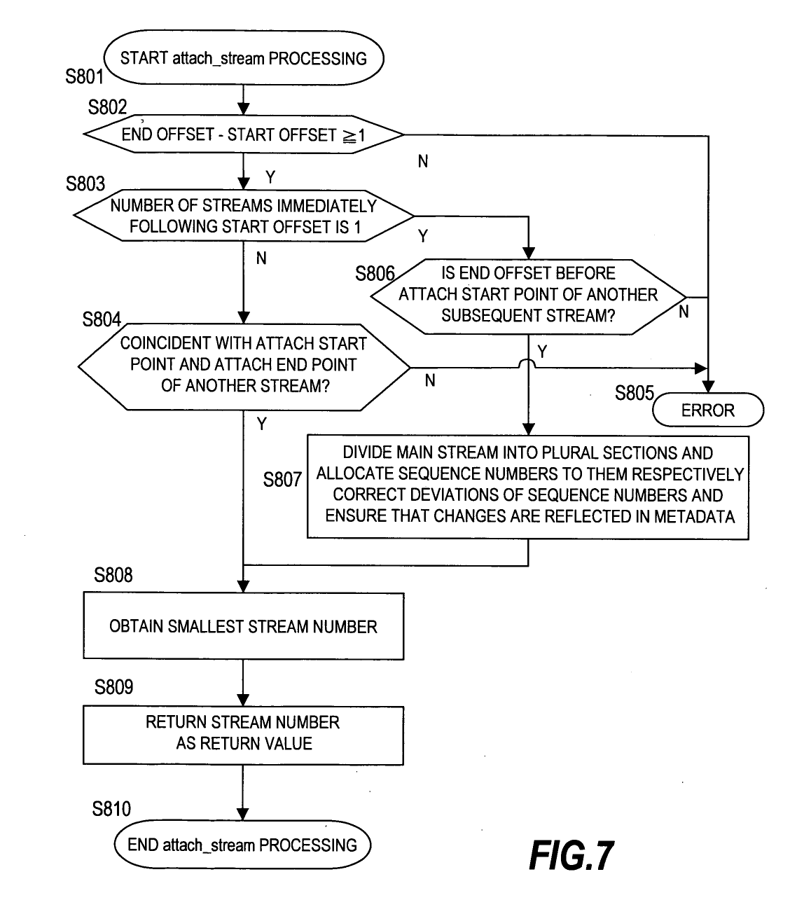

FIG. 7 is a flowchart of a processing of an attach_stream system call.

The attach_stream system call is intended to add (attach) a new stream to an existing file. By adding the stream to the file, it becomes possible to set a view corresponding to an access authorization.

In the attach_stream system call, start and end offsets are adopted as arguments. In the case of normal ending, an attached stream number is used as a return value. In the case of abnormal ending, an error number of a negative value is used as a return value.

When an attach_stream request is sent from the host computer 10 or the like, the request receiving module 110 receives the request, and issues an attach_stream system call to the request processing module 111. The request processing module 111 processes the attach_stream system call (S801).

First of all, the request processing module 111 calculates a difference between the start offset and end offset designated by arguments, and determines whether or not the difference is greater than at least one byte or more (S802).

When the difference between the start offset and the end offset is 0 byte or a negative value, no stream can be added. Thus, the request processing module 111 shifts the processing to S805 and issues an error message to the request receiving module 110, thus ending the processing.

When the difference between the start offset and the end offset is greater than at least one byte or more, the request processing module 111 checks the number of streams immediately following a start offset to which a stream is about to be attached (S803).

When the number of streams is 2 or more, the request processing module 111 shifts the processing to S804. When the number of streams is 1, the request processing module 111 shifts the processing to S806.

In S804, the request processing module 111 checks whether or not the start offset and end offset designated by the arguments coincide with attach start and attach end points of another stream already attached, respectively.

When they do not coincide with the existing attach start and attach end points respectively, the request processing module 111 shifts the processing to S805 and issues an error message to the request receiving module 110, thus ending the processing. When they coincide with the existing attach start and attach end points respectively, the request processing module 111 shifts the processing to S808.

In S806, the request processing module 111 checks whether or not the end offset of the argument has exceeded the attach start point of another subsequent stream.

When it has exceeded the attach start point of the subsequent stream, the request processing module 111 shifts the processing to S805 and issues an error message to the request receiving module 110, thus ending the processing. When it has not exceeded the attach start point of the subsequent stream, the request processing module 111 shifts the processing to S807.

By means of the foregoing processing, attaching extending across streams is regarded as an error. Further, attaching that does not coincide with the start and end point of a stream is also regarded as an error.

In S807, the request processing module 111 performs the following processing for a main stream, that is, data having the stream number 0.

First of all, the request processing module 111 divides the main stream into three blocks, namely, (1) a region before the start offset, (2) a region from the start offset to the end offset, and (3) a region after the end offset. As regards the regions (1) and (3), the blocks may have already been divided. In this case, the main stream is divided into four or more regions. Then appropriate sequence numbers are allocated to those regions respectively. A new sequence number is allocated to the region (2) through this processing. Therefore, the request processing module 111 corrects a deviation of the sequence number for the region (3), and ensures that these changes are reflected in the metadata 401. Then the request processing module 111 shifts the processing to S808.

In S808, the request processing module 111 obtains the minimum (smallest) stream number for a relevant region, and then adds an entry to the extent 420. This entry includes an obtained stream number and an appropriate sequence number. Furthermore, the subsequence number is 1, and the byte number is 0.

Next in S809, the request processing module 111 returns the stream number as a return value, thus ending the attach_stream system call.

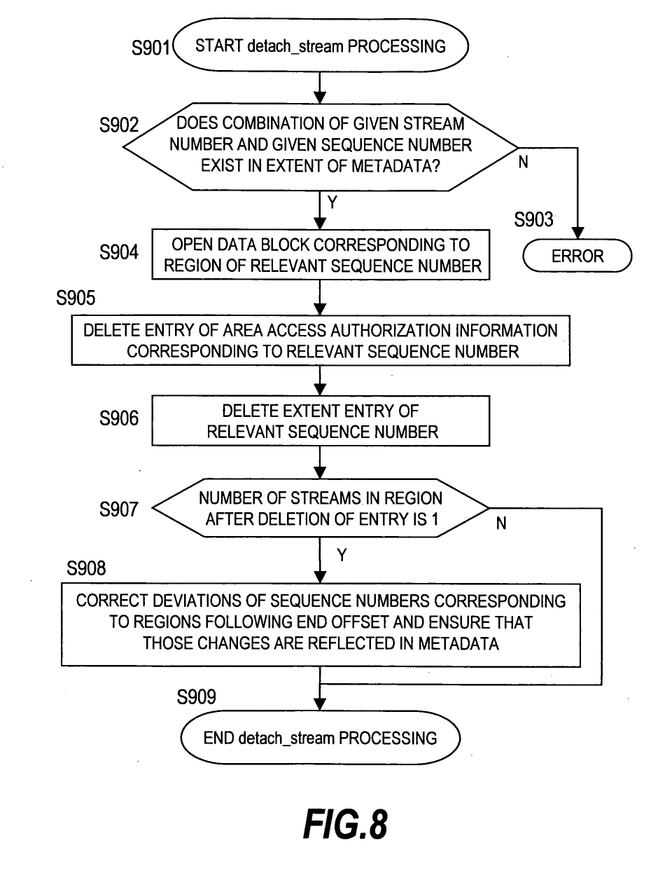

FIG. 8 is a flowchart of a processing of a detach_stream system call.

A detach_stream system call is intended to delete a stream set in a file.

In the detach_stream system call, a stream number and a sequence number are adopted as arguments. In the case of normal ending, an attached stream number is used as a return value. In the case of abnormal ending, an error number of a negative value is used as a return value. Instead of the sequence number, start and end offsets may be adopted as arguments.

When a detach_stream request is sent from the host computer 10 or the like, the request receiving module 110 receives the request, and issues a detach_stream system call to the request processing module 111. The request processing module 111 processes the detach_stream system call (S901).

First of all, the request processing module 111 checks whether or not a combination of a stream number and a sequence number given by the arguments exists in the entry of the extent 420 of the metadata 401 (S902).

When the entry does not exist in the extent 420, the request processing module 111 shifts the processing to S903 and issues an error message to the request receiving module 110, thus ending the processing.

When the entry exists in the extent 420, the request processing module 111 shifts the processing to S904 to open a data block of a region corresponding to the relevant sequence number.

Subsequently, the request processing module 111 deletes an entry of the area limitation access control 402 corresponding to the relevant sequence number (S905).

Subsequently, the request processing module 111 deletes an extent entry of the relevant sequence number (S906).

Subsequently, the request processing module 111 checks whether or not the number of streams in the relevant region is 1 after the entry has been deleted (S907).

When the number of streams is not 1, that is, 2 or more, the request processing module 111 ends the processing (S909). When the number of streams is 1, the request processing module 111 shifts the processing to S908 and corrects deviations of the sequence numbers for the regions following the end offset. In other words, the request processing module 111 corrects the sequence numbers that have deviated due to the deletion of one sequence number. Then the request processing module 111 ensures that the change is reflected in the metadata 401. In this case, the change is reflected for both the extent 420 and the area limitation access control 402. After the end of reflection, the request processing module 111 ends the processing (S909).

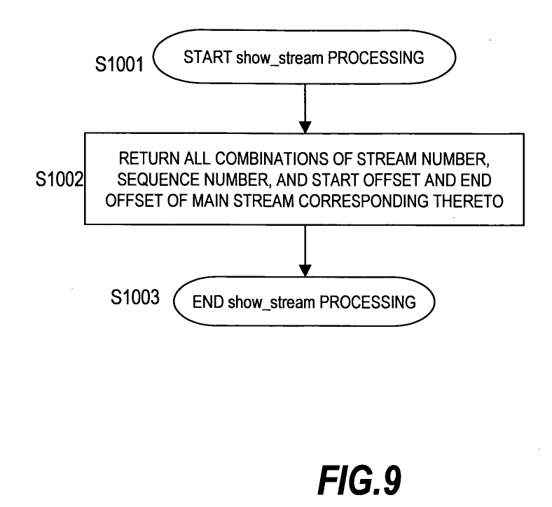

FIG. 9 is a flowchart of a processing of a show_stream system call.

A show_stream system call is intended to show a stream currently set in the file to a client.

When a show_stream request is sent from the host computer 10 or the like, the request receiving module 110 receives the request and issues a show_stream system call to the request processing module 111. The request processing module 111 processes the show_stream system call (S1001).

Upon receiving the show_stream system call, the request processing module 111 returns a stream number, a sequence number, and start and end offsets of a main stream as an attachment destination of the sequence number as return values, as to all combinations (S1002), and then ends the processing (S1003).

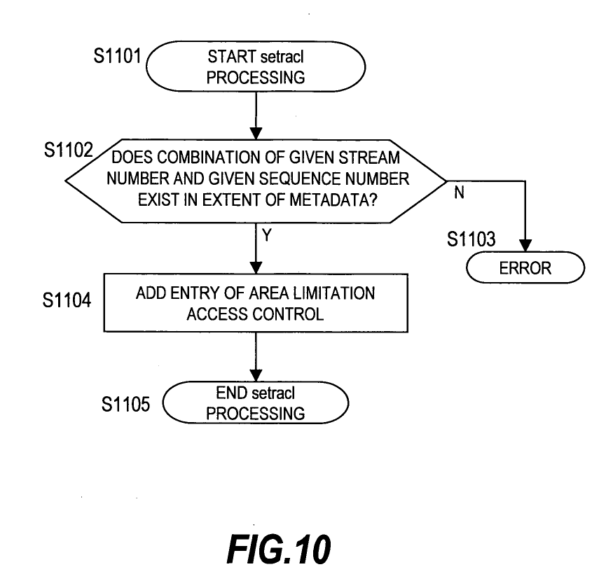

FIG. 10 is a flowchart of a processing of a setracl system call.

A setracl system call is intended to add a new area limitation access control information entry to the area limitation access control 402.

In the setracl system call, a stream number, a sequence number, a user or group ID, and an access authorization desired to be set are adopted as arguments. In the case of normal ending, 0 is used as a return value. In the case of abnormal ending, an error number of a negative value is used as a return value.

Instead of the sequence number, start and end offsets may be adopted as arguments.

When a setracl request is sent from the host computer 10 or the like, the request receiving module 110 receives the request and issues a setracl system call to the request processing module 111. The request processing module 111 processes the setracl system call (S101).

First of all, the request processing module 111 checks whether or not a combination of a stream number and a sequence number designated by the arguments exists in the extent 420 of the metadata 401 (S1102).

When the relevant stream does not exist in the extent 420, the request processing module 111 shifts the processing to S1103 and issues an error message to the request receiving module 110, thus ending the processing.

When the relevant stream exists in the extent 420, the request processing module 111 shifts the processing to S1104 and newly adds an entry of area limitation access control information to the area limitation access control 402 based on the contents given by the arguments, thus ending the processing (S1105).

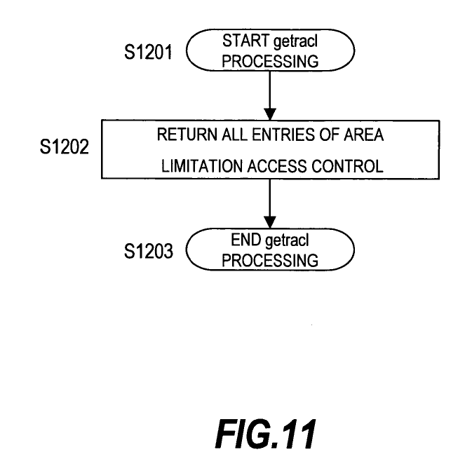

FIG. 11 is a flowchart of a processing of a getracl system call.

A getracl system call is intended to output the contents of an entry of the area limitation access control.

When a getracl request is sent from the host computer 10 or the like, the request receiving module 110 receives the request and issues a getracl system call to the request processing module 111. The request processing module 111 processes the getracl system call (S1201).

Upon receiving the getracl system call, the request processing module 111 returns the contents of all the entries of the area limitation access control 402 as return values (S1202), thus ending the processing (S1203).

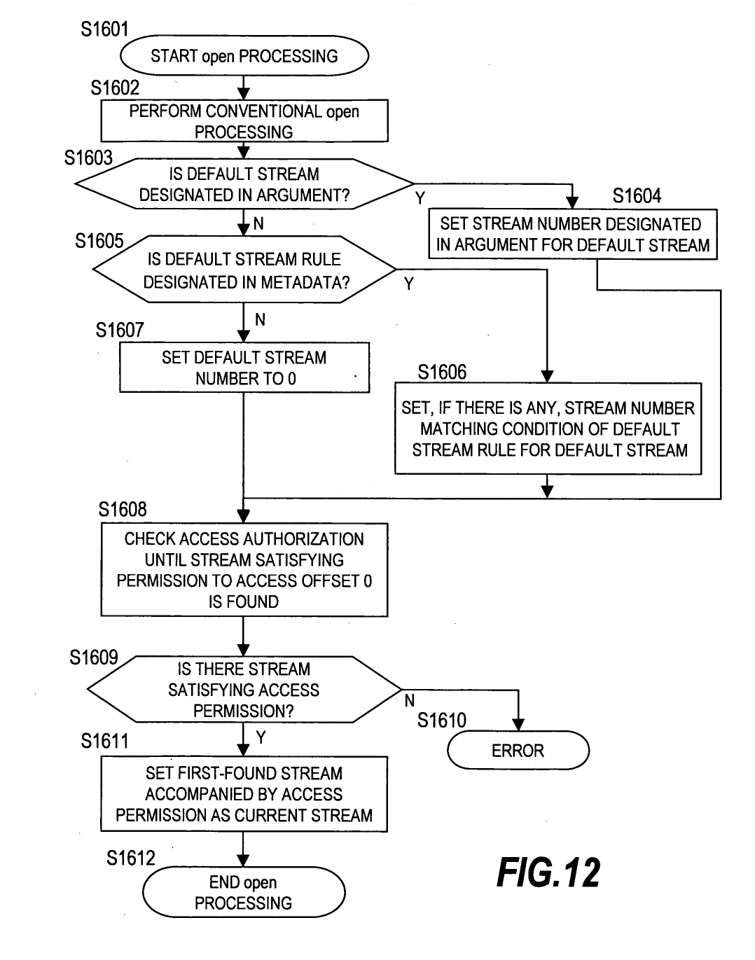

FIG. 12 is a flowchart of a processing of an open system call.

An open system call, which is a processing in a preliminary step before accessing a file, is intended to set the file to be accessible.

The open system call of this embodiment is obtained by adding a processing regarding an access authorization to the open system call used in the conventional file systems. Thus, the open system call of this embodiment is compatible with the open system call used in the conventional file systems.

In the open system call, a default stream number is adopted as an argument in addition to the path name and flag of the conventional file systems. A file descriptor and a current stream number are used as return values.

When an open request is sent from the host computer 10 or the like, the request receiving module 110 receives the request and issues an open system call to the request processing module 111. The request processing module 111 processes the open system call (S1601).

First of all, the request processing module 111 performs the conventional open processing. More specifically, the request processing module 111 carries out the checking of an access authorization, retrieval of a path name, generation of a structure and a file descriptor that need to be prepared every time the open processing is performed, and the like (S1602).

Subsequently, the request processing module 111 checks whether or not a default stream number is designated as an argument (S1603).

When a default stream number is designated, the request processing module 111 shifts the processing to S1604 and sets a stream number designated as an argument into the default stream. The request processing module 111 then shifts the processing to S1608.

When no default stream number is designated as an argument, the request processing module 111 shifts the processing to S1605 and checks whether or not a rule is designated in the default stream rule 404 of the metadata 401.

When a rule is designated, the request processing module 111 shifts the processing to S1606. In S1606, the request processing module 111 checks a condition designated in the default stream 404.

In the example of the default stream rule 404 shown in FIG. 6, the default stream is set to 1 when there is an access from a specific client (client1). Further, the default stream is set to 2 when there is an access during a specific time period (from 10:00 to 22:00). Further, the default stream is set to 2 when there is an access from a specific process name (smbd).

On the other hand, when no rule is designated, the request processing module 111 shifts the processing to S1607. In S1607, the request processing module 111 sets the default stream number to 0.

By means of the foregoing processing, the request processing module 111 sets a default stream designated in the condition of the default stream rule 404 when the condition is fulfilled. The request processing module 111 sets the default stream number to 0 when the condition is not fulfilled. In other words, any one of the default stream numbers is set in a file corresponding to the open system call.

Next, the request processing module 111 sequentially checks the whether or not satisfying an access permission with an offset 0, in the order of default stream and stream access priority (S1608). The request processing module 111 then determines whether or not there is a stream which is satisfied access permission (S1609).

When there is a stream satisfying access permission, the request processing module 111 shifts the processing to S1611. When there is no stream satisfying access permission, the request processing module 111 shifts the processing to S1610 and issues an error message to the request receiving module 110, thus ending the processing.

In S1611, the request processing module 111 sets a first-found stream satisfying access permission as a current stream. At this moment, the request processing module 111 also sets the current offset 107, the current sequence number 105, and the current sequence offset 106. After that, the request processing module 111 ends the processing of the open system call (S1612). In ending the processing, the request processing module 111 returns the current stream as an argument, using the file descriptor as a return value.

The processing of S1608 will be described specifically.

It is assumed that the default stream number is set to 1, and that there is an open request access from a user having attributes of a user ID 5 and the group ID 2. First of all, the request processing module 111 refers to the area limitation access control 402 and checks whether or not satisfying an access authorization for the user in the stream 1 as a default stream. In the area limitation access control 402 shown in FIG. 4, for the user, there is no entry permitting the offset 0 with the stream number 1 (i.e., the sequence number is 1). Thus, the user's access is rejected. Therefore, the request processing module 111 subsequently refers to the stream access priority 403 and checks satisfying an access authorization. The stream 0 is designated at the head of the stream access priority 403 shown in FIG. 5. Thus, the request processing module 111 refers to the area limitation access control 402 and checks whether or not satisfying an access authorization for the user in the offset 0 with the stream 0. In this case, a user with the group ID 2 in the fourth entry is given an authorization “R” for the stream number 0 and the sequence number 1, namely, is allowed to read. Thus, the request processing module 111 sets the current stream satisfying access permission to 0.

For instance, when there is an open request from a user having attributes of a user ID 6 and a group ID 10, the request processing module 111 issues an error message and ends the processing because the request is not satisfied the access authorization for the user in the offset 0.

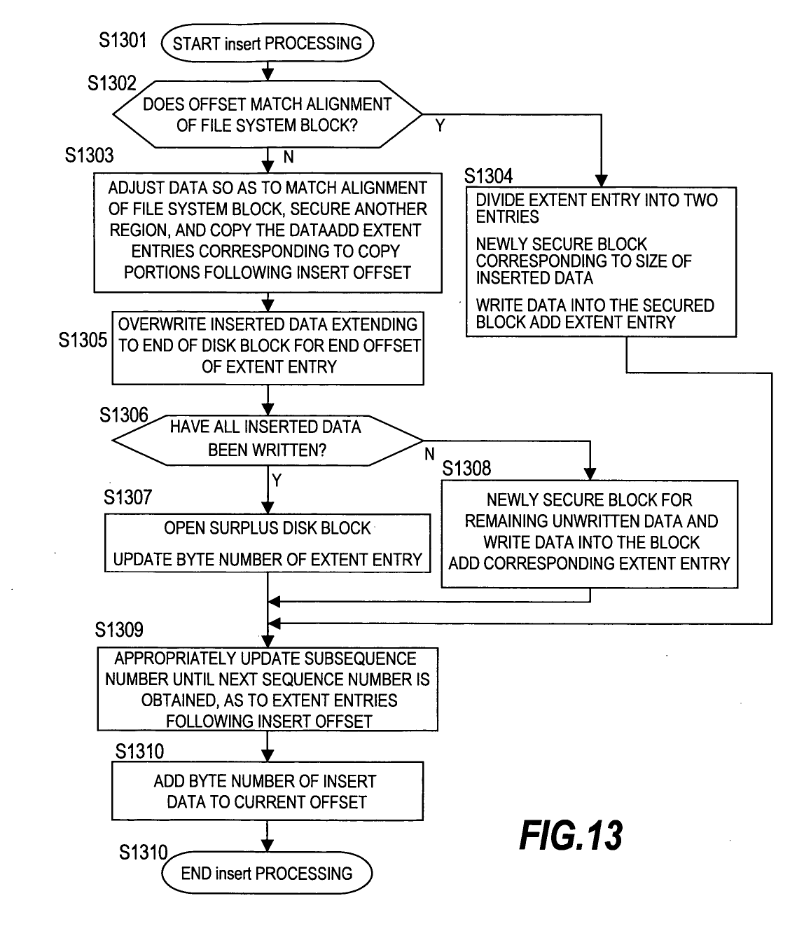

FIG. 13 is a flowchart of a processing of an insert system call.

The insert system call is intended to insert data into a file. In the insert system call, a file descriptor, an inserted buffer, the size of the buffer, and a flag indicating whether inserted data are located to the left of the current offset or to the right of the current offset are adopted as arguments. This flag is valid only at a changeover point of sequence numbers. When this flag is omitted, the data are inserted to the right of the current offset. In the case of normal ending, the size of the inserted data is used as a return value. In the case of abnormal ending, an error number of a negative value is used as a return value.

The request processing module 111 inserts data using a current stream number, a current sequence number, and a location indicated by a current sequence offset.

When an insert request is sent from the host computer 10 or the like, the request receiving module 110 receives the request and issues an insert system call to the request processing module 111. The request processing module 111 processes the insert system call (S1301).

First of all, the request processing module 111 checks whether or not an offset into which data are about to be inserted coincides with the alignment of a file system block (S1302).

When the offset into which the data are about to be inserted coincides with the alignment, the request processing module 111 shifts the processing to S1304. On the other hand, when the offset does not coincide with the alignment, that is, when the data are inserted across different file system blocks, the request processing module 111 shifts the processing to S1303.

In S1303, the request processing module 111 newly secures a region for an extent entry including an insert offset, and copies data extending from the insert offset to an end offset of the extent entry into the newly secured region. In this case, the request processing module 111 copies the data first to the head of the newly secured region, that is, copies the data while ensuring coincidence with the alignment. The request processing module 111 then adds an extent entry corresponding to a data-copied portion following the insert offset.

Subsequently, the request processing module 111 overwrites the inserted data extending from the insert offset to the end of a disk block indicated by the extent entry including the insert offset (S1305).

Subsequently, the request processing module 111 checks whether or not all the inserted data have been written into the block indicated by the extent entry (S1306). When all the data have been written, the request processing module 111 shifts the processing to S1307 and opens an unused area of the block indicated by the extent entry. Further, irrespective of whether the block has been opened or not, the request processing module 111 updates the byte number of the extent entry into that of the currently retained valid data.

When all the data have not been written, the request processing module 111 shifts the processing to S1308 and newly secures a block corresponding to the remaining unwritten data. The request processing module 111 then writes the data into the newly secured block, and adds a corresponding extent entry.

In S1302, when the data insert offset coincides with the alignment of the file system block, the request processing module 111 shifts the processing to S1304. In S1304, the request processing module 111 first divides the extent entry including the insert offset into two entries. The request processing module 111 then newly secures a block corresponding to the size of inserted data and writes the data into the secured block. Further, the request processing module 111 adds an extent entry corresponding to the newly secured block.

By means of the foregoing processing, the inserted data are written.

After that, the request processing module 111 appropriately updates the subsequence numbers as to extent entries following the insert offset (S1309). For example, when one extent entry has been added, the request processing module 111 adds 1 to the subsequence numbers of the following extent entries respectively.

Subsequently, the request processing module 111 adds the byte number of the inserted data to the current offset (S1310). At this moment, the request processing module 111 updates the current sequence offset as well in the same manner.

After that, the request processing module 111 returns the byte number of the successfully inserted data as a return value, thus ending the processing of the insert system call (S1311).

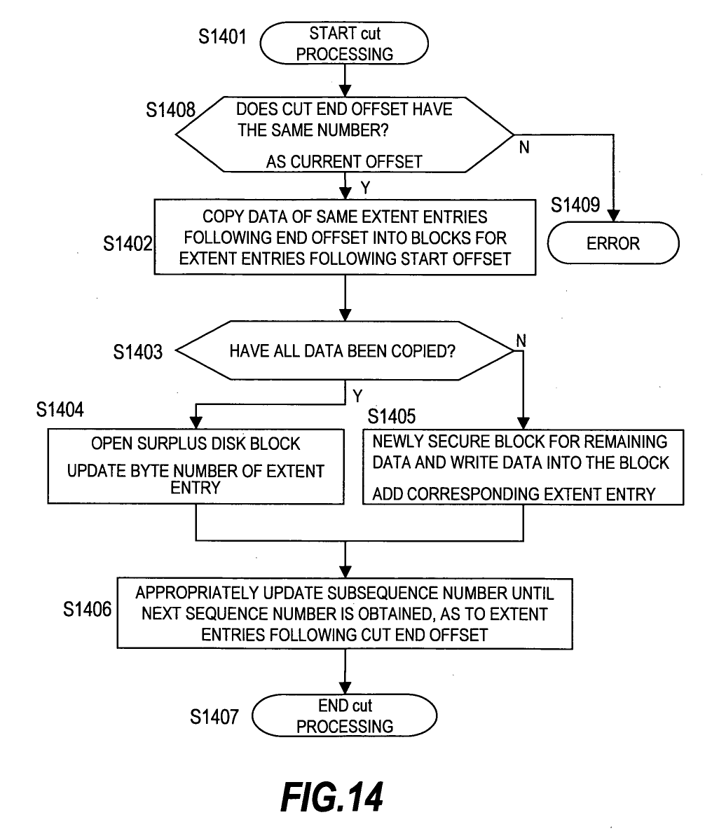

FIG. 14 is a flowchart of a processing of a cut system call.

A cut system call is intended to cut part of file data. In the cut system call, a file descriptor and a cut length are adopted as arguments. A length of successfully cut data is used as a return value.

When a cut request is sent from the host computer 10 or the like, the request receiving module 110 receives the request and issues a cut system call to the request processing module 111. The request processing module 111 processes the cut system call (S1401).

First of all, the request processing module 111 checks whether or not a cut start offset (current offset) has the same sequence number as a cut end offset (a value obtained by adding a cut length to the current offset) (S1408).

When the cut start offset does not have the same sequence number as the cut end offset, such a cutting operation is impossible. Therefore, the request processing module 111 shifts the processing to S1409 and issues an error message to the request receiving module 110, thus ending the processing.

When the cut start offset has the same sequence number as the cut end offset, the request processing module 111 shifts the processing to S1402.

In S1402, the request processing module 111 copies the data in the same extent entries following the cut end offset into the blocks for the extent entries following the cut start offset (current offset).

Subsequently, the request processing module 111 checks whether or not all the data have been copied (S1403).

After copying all the data, the request processing module 111 opens unused ones of the disk blocks for the extent entries (S1404). At this moment, the request processing module 111 updates the byte numbers of the extent entries irrespective of whether those disk blocks have been opened or not.

On the other hand, when all the data are not copied, the request processing module 111 newly secures a block corresponding to the remaining unwritten data. The request processing module 111 then writes the remaining data into the newly secured block (S1405). At this moment, the request processing module 111 adds an extent entry corresponding to the newly secured block.

After ending the processing of S1404 or S1405, the request processing module 111 appropriately updates the subsequence numbers as to the extent entries following the cut end offset until the next sequence number is obtained (S1406). After that, the request processing module 111 returns the byte number of the cut data as a return value, thus ending the processing of the cut system call (S1407).

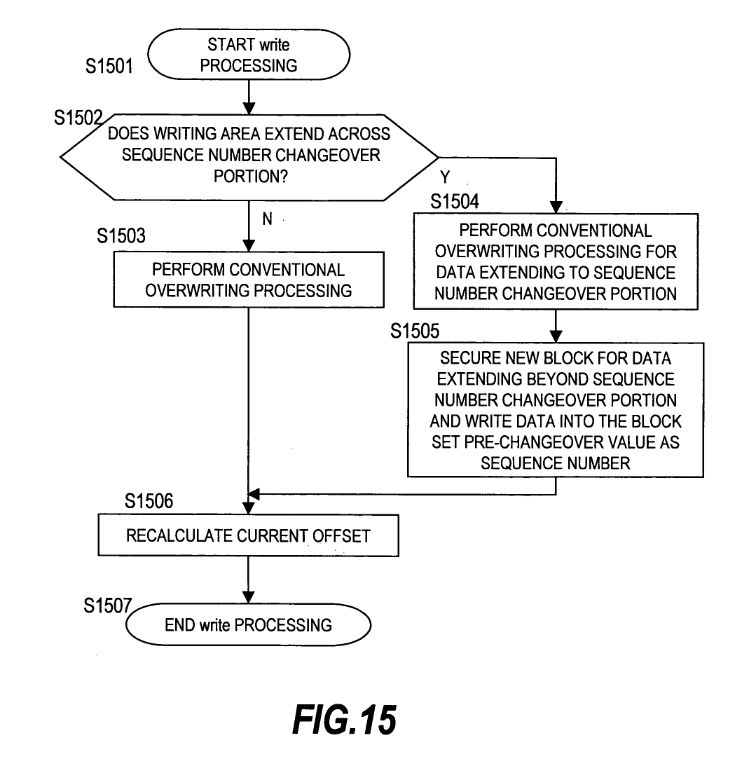

FIG. 15 is a flowchart of a processing of a write system call.

In the processing of a write system call of this embodiment, nothing is written beyond any sequence number so as to prevent the continuity with other streams from being affected.

In the write system call, as is the case with a conventional write system call, a file descriptor, a buffer, and a writing size are adopted as arguments. In the case of normal ending, the size of successfully written data is returned as a return value. In the case of abnormal ending, an error number of a negative value is returned as a return value.

When a write request is sent from the host computer 10 or the like, the request receiving module 110 receives the request and issues a write system call to the request processing module 111. The request processing module 111 processes the write system call (S1501).

First of all, the request processing module 111 checks whether or not a writing area extends across a sequence number changeover portion (S1502). When the writing area does not extend across the sequence number changeover portion, the request processing module 111 shifts the processing to S1503 and performs a conventional overwriting processing. In other words, the request processing module 111 does not perform any processing regarding the sequence numbers in this case.

On the other hand, when the writing area extends across the sequence number changeover portion, the request processing module 111 first performs a conventional writing processing for data over a range extending from the head thereof to the sequence number changeover portion, thus overwriting the data (S1504).

Subsequently, the request processing module 111 first newly secures a block for the data extending beyond the sequence number changeover portion, and writes the remaining data into the newly secured block (S1505). The request processing module 111 then adds an extent entry corresponding to the newly secured block. The request processing module 111 sets the sequence number of the added extent entry to the same value as the sequence number before the sequence number changeover portion, namely, the sequence number of the start offset. Further, the request processing module 111 uses an appropriate value as the subsequence number according to a writing location.

After ending the processing of S1503 or S1505, the request processing module 111 recalculates a current offset (S1506). At the same time, the request processing module 111 recalculates a current sequence offset as well.

After that, the request processing module 111 returns the byte number of successfully written data as a return value, thus ending the processing of the write system call (S1507).

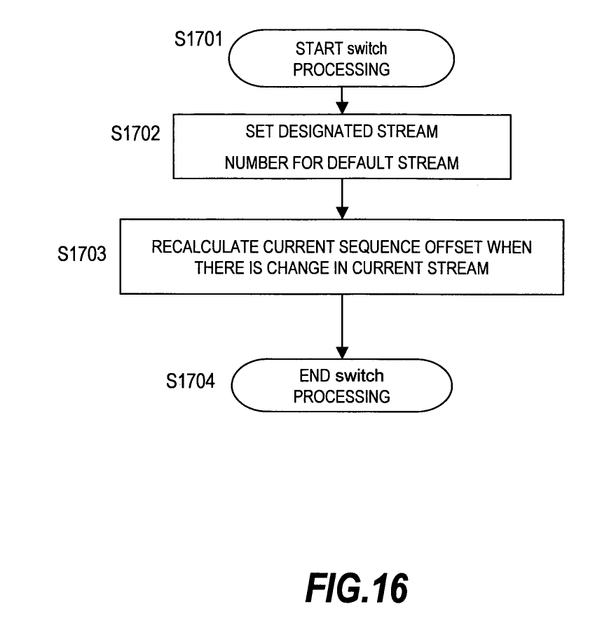

FIG. 16 is a flowchart of a processing of a switch system call.

A switch system call is intended to perform changeover of default streams.

In the switch system call, a file descriptor and a default stream number desired to be set are adopted as arguments. In the case of normal ending, a current stream number is used as a return value. In the case of a failure, an error number of a negative value is used as a return value.

When a switch request is sent from the host computer 10 or the like, the request receiving module 110 receives the request and issues a switch system call to the request processing module 111. The request processing module 111 processes the switch system call (S1701).

First of all, the request processing module 111 sets a stream number designated by the argument into a default stream (S1702).

Subsequently, when the current stream is changed through a change in the default stream, the request processing module 111 recalculates a current sequence number and a current sequence offset (S1703).

After that, the request processing module 111 returns a current stream number as a return value, thus ending the processing of the switch system call (S1704).

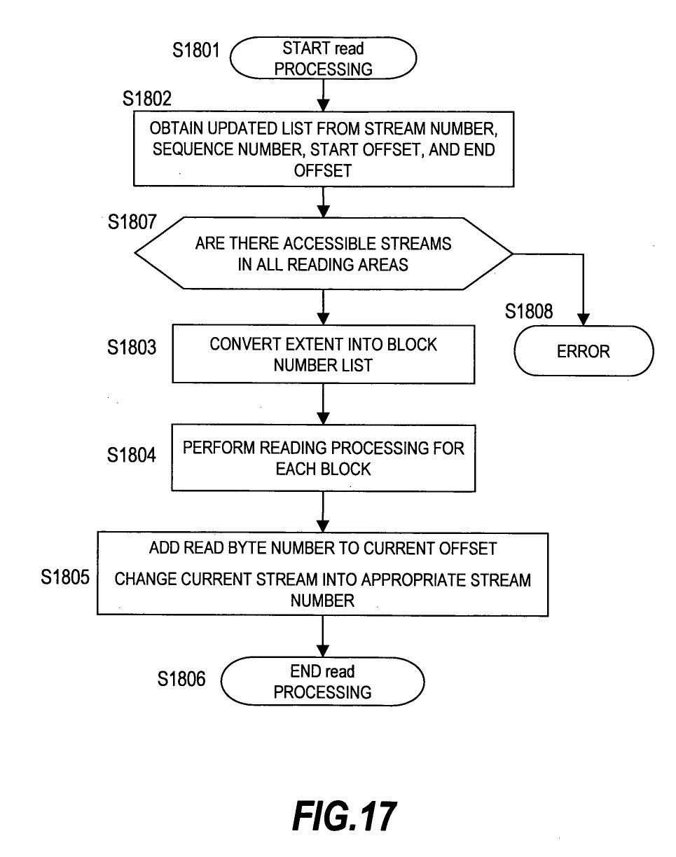

FIG. 17 is a flowchart of a processing of a read system call.

A read system call is intended to perform a processing of reading file data corresponding to the stream of this embodiment. In the read system call, as is the case with a conventional read system call, a file descriptor, a read buffer, and a reading size are adopted as arguments.

When a read request is sent from the host computer 10 or the like, the request receiving module 110 receives the request and issues a read system call to the request processing module 111. The request processing module 111 processes the read system call (S1801).

First of all, the request processing module 111 refers to the area limitation access control 402, the stream access priority 403, and the default stream rule 404. The request processing module 111 then obtains a list of extents composed of a stream number, a sequence number, a start offset, and an end offset (S1802).

Subsequently, the request processing module 111 refers to the obtained list and checks whether or not there are accessible (satisfying access permission) streams in all the reading areas (S1807). The accessible streams are the same as those described in the aforementioned open processing. The processing is performed in all the designated reading areas.

When there is not a region satisfying access permission in at least some of the reading areas, the request processing module 111 shifts the processing to S1808 and issues an error message to the request receiving module 110, thus ending the processing. Instead of issuing the error message to end the processing, the request processing module 111 may read data extending to an offset of an accessible area.

When there are accessible streams in all the reading areas, the request processing module 111 shifts the processing to S1803. In S1803, the request processing module 111 converts the obtained list of the extents into a new list in which the extents are rearranged in the order of block number.

Subsequently, the request processing module 111 performs the reading processing for the respective blocks (S1804). The read data are sent to their request source.

Subsequently, the request processing module 111 adds the read byte number to the current offset (S1805). At this moment, the request processing module 111 changes the current stream, the current sequence number, and the current sequence offset as well based on the read byte number.

After that, the request processing module 111 returns the read byte number as a return value, thus ending the read system call (S1806).

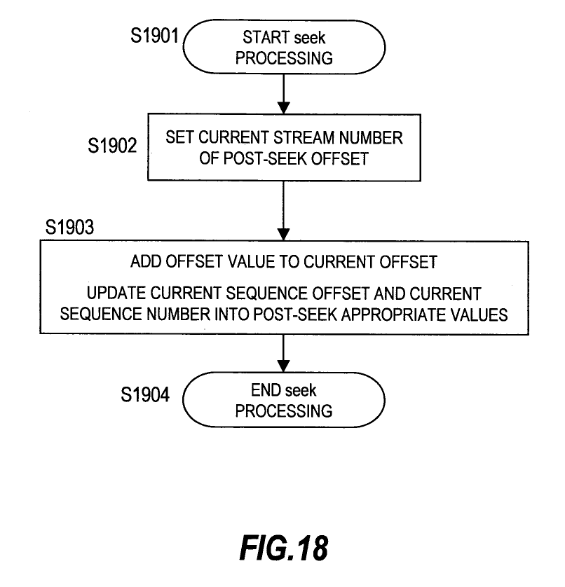

FIG. 18 is a flowchart of a processing of a seek system call.

A seek system call is intended to change a current offset corresponding to the stream of this embodiment. In the seek system call, as is the case with the conventional seek system call, a file descriptor, an offset, and a flag are adopted as arguments. A post-seek offset is used as a return value.

When a seek request is sent from the host computer 10 or the like, the request receiving module 110 receives the request and issues a seek system call to the request processing module 111. The request processing module 111 processes the seek system call (S1901).

First of all, the request processing module 111 refers to the area limitation access control 402, the stream access priority 403, and the default stream rule 404. The request processing module 111 then sets a current stream of the post-seek offset (S1902).

Subsequently, the request processing module 111 adds an offset value designated by the argument to the current offset. The request processing module 111 then updates the current sequence offset and the current sequence number into post-seek values (S1903).

After that, the request processing module 111 returns the offset value as a return value, thus ending the seek system call (S1904).

As described above, the file system according to the first embodiment of this invention manages the file data using stream numbers and sequence numbers. Further, the file system manages access authorizations for the respective streams using the area limitation access control 402. It is thus possible to change the view of file data according to the access authorization for a client as a request source.

Next, a second embodiment of this invention will be described.

As described above, the first embodiment is adapted to manage the respective streams using the extents of the file. In contrast, the second embodiment is adapted to manage each of the streams as a single file. The elements having the same configuration as those of the first embodiment are denoted by the same reference numerals or symbols, and description thereof will be omitted.

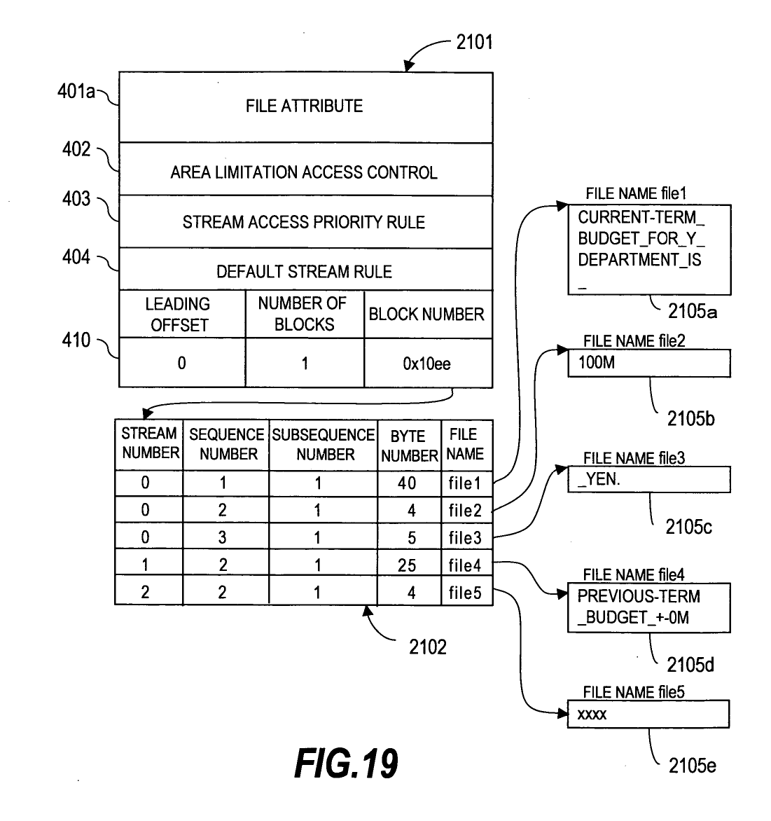

FIG. 19 is a schematic diagram of a file system realized by a computer system according to the second embodiment of this invention.

A file for managing each stream is referred to as a metafile. The metafile is composed of a metadata 2101 and a user data 2102.

As is the case with the first embodiment, the metadata 2101 include the area limitation access control 402, the stream access priority 403, and the default stream rule 404 in addition to the file attribute 401a of the conventional file system.

The metadata 2101 includes an extent 410. This extent 410 indicates a storage area for the user data 2102 corresponding to the metadata. In the example shown in FIG. 19, a block number 0x10ee is indicated by the extent 410. Stream numbers, sequence numbers, subsequence numbers, and file names corresponding to them respectively are stored in the user data 2102 stored in the block number 0x10ee in the form of a list.

The processing of the thus-configured file system of the second embodiment is the same as that of the file system of the aforementioned first embodiment, except in that the contents of the sequence constituting each stream are available as a file.

In the second embodiment, the metadata 2101 of the metafile have the area limitation access control 402. However, the metadata 2101 may also be access restricting information specific to each file indicated by the metafile. In other words, it is also appropriate to determine the access authorization for a stream by the access authorization specific to the file.

As described above, as is the case with the aforementioned first embodiment, the file system according to the second embodiment of this invention makes it possible to change the view of file data according to the access authorization for a client as a request source. In particular, the file system of the second embodiment manages each sequence constituting a stream as a file, and thus makes it possible to perform access control more finely by setting an access authorization for each sequence.

This invention is applicable to file systems, NAS's, and the like. The contents as targets of this invention are supposed to be video image files, documents, execution modules, and the like. A video image file retains plural image streams, which are changed over from one to another so as to be reproduced according to one's age, nationality, or taste. A document displays an appropriate stream of confidential information level according to one's post or an organization to which one belongs. An execution module retains binary data corresponding to plural architectures and executes the binary data of an appropriate one of the architectures.

While the present invention has been described in detail and pictorially in the accompanying drawings, the present invention is not limited to such detail but covers various obvious modifications and equivalent arrangements, which fall within the purview of the appended claims.

What is claimed is:

1. A file providing method for providing file data corresponding to an access authorization for an access source, comprising:
setting an access authorization for each of data in a predetermined region of a file;
concatenating the data satisfying the access authorization for the access source according to a predetermined combination; and
providing the access source with the concatenated data.

2. The file providing method according to claim 1, further comprising:
setting identifiers designating the predetermined combination and access authorization for each identifier;
selecting one of the identifiers satisfying the access authorization for the access source;
concatenating the data according to a combination designated by the selected identifiers; and
providing the access source with the concatenated data.

3. The file providing method according to claim 2, wherein the identifier comprises:
a block position in a file of the data;
a sequence number designating an order in which the data are concatenated; and
a stream number designating a combination of the data.

4. The file providing method according to claim 1, further comprising:
setting a block position in the file of the data, a sequence number designating an order in which the data are concatenated, a stream number designating a combination of the data, and an access authorization for each stream numbers;
selecting a stream number satisfying the access authorization for the access source;
concatenating the data according to a combination designated by the selected stream number; and
providing the access source with the concatenated data.

5. The file providing method according to claim 4, further comprising:
setting a first stream number as a basic stream number and an order of priority of the stream numbers;
determining whether or not the access authorization for the access source satisfies an access authorization for the first stream number; and
then, determining whether or not the access authorization for the access source satisfying the access authorization for each stream number based on the order of priority.

6. The file providing method according to claim 4, further comprising:
setting a first stream number as a basic stream number based on one of an access time, a client of the access source, and a process name of the access source and an order of priority of the stream numbers;
determining whether or not the access authorization for the access source satisfies an access authorization for the first stream number; and
then, determining whether or not the access authorization for the access source satisfying the access authorization for each stream number based on the order of priority.

7. The file providing method according to claim 4, further comprising setting a new stream number by designating at least one of an information including a start offset and an end offset and an information including a sequence number.

8. The file providing method according to claim 4, further comprising deleting the stream number by designating at least one of an information including the stream number, an information including a start offset and an end offset, and an information including a sequence number.

9. The file providing method according to claim 4, further comprising:
setting a first stream number as a basic stream number and an order of priority of the stream numbers;
determining whether or not there is a designation of the first stream number as the basic stream number from the access source;
changing the first stream number into a stream number regarding the designation;
determining whether or not the access authorization for the access source satisfies an access authorization for the first stream number; and
then, determining whether or not the access authorization for the access source satisfying the access authorization for each stream number based on the order of priority.

10. The file providing method according to claim 4, wherein the block position, the sequence number, the stream number, and the access authorization for each stream number are stored in metadata for managing the file.

11. The file providing method according to claim 4, further comprising:
inserting data into the file by designating an offset and the data to be inserted; and
changing the sequence number corresponding to existing data stored behind a position of the offset based on a capacity of the inserted data.

12. The file providing method according to claim 4, further comprising:
deleting data by designating an offset and a data length;
calculating a sum of the offset and the data length; and
changing the sequence numbers of existing data stored behind a position of the calculated sum based on the data length.

13. A file providing method for providing file data corresponding to an access authorization for an access source, comprising:
setting an order in which files are concatenated, combination of the files, and an access authorization for each combination;
concatenating the files according to the combination satisfying the access authorization for the access source; and
providing the access source with the concatenated files.

14. The file providing method according to claim 13, further comprising:
setting access authorizations for the respective files;
concatenating the files satisfying the access authorization for the access source according to the combination; and
providing the access source with the concatenated files.

15. A storage system for providing, based on a request from the host computer, file data stored in a disk drive comprising:
a network interface communicating with a host computer;
a disk interface communicating with the disk drive; and
a control module,
wherein a control module;
sets access authorizations for respective data in a predetermined region of a file in the storage system;
concatenates the data satisfying an access authorization regarding the request according to a predetermined combination; and
provides a source of the request with the concatenated data.

16. The storage system according to claim 15, wherein the control module:
sets a block position in the file of the data, a sequence number designating a position in which the data are concatenated, a stream number designating a combination of the data, and access authorizations for the respective stream numbers;
selects the stream number satisfying the access authorization for the source of the request;
concatenates the data according to a combination designated by the selected stream number; and
provides the source of the request with the concatenated data.

17. A file providing program for providing, based on a request from a host computer, file data stored in a disk device in a storage system including a network interface communicating with the host computer a disk interface communicating with the disk device and a control module, the file providing program comprising:
a first procedure of setting access authorizations for respective data in a predetermined region of a file in the storage system;
a second procedure of concatenating the data satisfying an access authorization regarding the request according to a predetermined combination; and
a third procedure of providing a source of the request with the concatenated data.

18. The file providing program according to claim 17, further comprising:
a fourth procedure of setting a block position in the file of the data, a sequence number designating an order in which the data are concatenated, a stream number designating a combination of the data, and an access authorization for each stream number;
a fifth procedure of selecting the stream number satisfying the access authorization for the source of the request; and
a sixth procedure of concatenating the data according to a combination designated by the selected stream number.
